(19) United States
(12) Patent Application Publication
(10) Pub. No.: US 2007/0252678 A1
(43) Pub. Date: Nov. 1, 2007

(54) Method and Apparatus for Tele-Toll Payment

(76) Inventors: Javier Garcia Alonso, Madrid (ES); Juan Antonio Sanchez Herrero, Madrid (ES)

Correspondence Address: ERICSSON INC., 6300 LEGACY DRIVE, M/S EVR 1-C-11, PLANO, TX, 75024, US

(21) Appl. No.: 11/573,176

(22) PCT Filed: Aug. 3, 2004
(86) PCT No.: PCT/SE04/01165

§ 371 Date: Feb. 2, 2007

(51) Int. Cl. H04Q 5/22

(52) U.S. Cl. 340/10.31

(57) ABSTRACT

Method, apparatus and system for processing the debiting of a toll events for vehicles. A toll control server (100) stores a voucher assertion (1032) in relationship with a toll identifier (T-ID) obtainable from a vehicle (V1). When a toll event (405) reported from a reading station (11) comprising a toll identifier obtained from a vehicle is going to be processed, it is checked whether a voucher assertion exists in relationship with the obtained toll identifier. After checking the existence of a voucher assertion for the obtained identifier, and the conditions eventually stated on it, the payment of the toll event is ascribed to the default payment account (ACCT) for said identifier or to a second payment account. The toll control server may receive from an application server (300) payment authorization or payment revocation requests for a toll identifier, which makes it to store or remove a voucher assertion for it.

### FIELD OF THE INVENTION

The present invention relates to automatic toll systems, and more precisely to a method, apparatuses and a system for processing the debiting of a toll for a vehicle.

### BACKGROUND

Currently, automatic toll systems for vehicles, also known as “tele-toll systems”, are becoming widely used as they provide advantages for the users, who does not need to stop their vehicles to manually pay a toll, as well as advantages for toll operators, which can benefit from a reliable toll control and toll debiting technique.

A tele-toll system usually comprises a plurality of reading stations and one or more toll control servers performing toll control and toll debiting functions, and its operation involves an automatic identification of a vehicle traveling through a toll road and the ascription of the debit of the corresponding toll fee to an associated payment account.

In short, reading stations collect toll events by reading toll identifiers from vehicles that pass by their respective reading area, which are further processed by toll control servers. The toll identifier obtainable from a vehicle can vary depending on the technology used by the reading stations of a tele-toll system. For example, it can comprise an alphanumeric sequence of characters obtainable from the license plate of a vehicle, or comprise a code obtainable from another kind of support carried by the vehicle. Short-range radio frequency is a technology commonly used in reading stations to read a toll identifier from a vehicle, although other technologies, such as image capturing followed by optical character recognition, can be utilized in replacement or in addition to it. For this purpose, vehicles that use a tele-toll system usually carry an on board equipment (OBE) that comprises a radio transponder arranged to receive an interrogation signal from a reading station and to transmit a response a signal that conveys the toll identifier of the vehicle.

A user who wants to benefit from the tele-toll payment feature provided by a tele-toll operator installs on his vehicle an OBE arranged to emit a particular toll identifier, and signs an agreement that grants the ascription of debits of toll events comprising said toll identifier to a payment account (usually, a bank account of the user).

The toll events reported from a reading station are processed by a toll control server. Primarily, a toll control server may perform a validity check for the obtained toll identifier, for example, to determine whether the obtained toll identifier is valid (e.g. it has been previously provisioned as a valid toll identifier by the tele-toll operator, it has associated a valid payment account, etc). Accordingly, a further action may be taken based on an unsuccessful result of said check, such as: block the pass of the vehicle by means of a barrier, issue a warning signal to request the vehicle to stop, take a picture of the vehicle comprising its license plate, etc. Independently of the result of the aforementioned check, a toll control server may store data of the toll event into a toll event log, which, for a given toll identifier, may contain information about the time and/or locations in which toll events comprising said identifier have taken place.

A further task for a toll control server is to ascribe the debit of the toll events reported by one or more reading stations. This task may be performed by the same toll control server that performs the aforementioned validity check, or by another toll control server specialized in this particular task; being this an implementation option that may depend, for example, on whether on-line or off-line debit processing applies. For example, the balance of a payment account, or the accounting information of toll events to be debited to said account, may be on-line updated at reception from a reading station of a toll event comprising the toll identifier it relates to. Alternatively, toll events collected during a given period of time, may be off-line processed so as to ascribe the debit of the total toll fees for that period to the corresponding payment accounts.

Tele-toll is an advantageous solution for users who drive most of the times the same vehicle and who are frequent users of toll roads. However, the characteristics of current tele-toll solutions may do not suit with some situations, which delays a wider deployment and use of tele-toll systems. For example, a user may be reluctant to sign a tele-toll agreement if he use just occasionally toll roads. Even for a frequent user of toll roads who have installed an OBE on his vehicle, it may be inconvenient to lend his vehicle to other person during a given period since, although said other person may be willing to pay for toll events incurred by the vehicle in said period, it may be difficult, or embarrassing, to determine the amount to be paid. Also, a car rental company might want to install OBEs on its vehicles, so as to offer the advantages of tele-toll payment to its clients as a value-added feature. However, the car rental company might experience some difficulties to collect the toll fees due from a client, since the payment account of said company will likely be debited with the tolls events incurred by said client once he gave back the car and paid the car rental fee.

Therefore, it is an object of the present invention to provide a method and apparatuses for tele-toll payment which alleviates the aforementioned disadvantages.

### SUMMARY OF THE INVENTION

The aforementioned object is achieved by a method as claimed in claim 1. This object is also achieved by an apparatus as claimed in claim 11 or by a system as claimed in claim 28. Embodiments of the invention are set out in the dependent claims.

In one aspect, the invention relates to a method for processing the debiting of a toll event comprising a toll identifier obtained from a vehicle. In another aspect, the invention relates to a toll control server for controlling the debiting of a toll event comprising a toll identifier obtained from a vehicle. The method and toll control server according to the invention are characterized in that a voucher assertion is stored in relationship with a toll identifier obtainable from a vehicle. When a toll event reported from a reading station and comprising a toll identifier obtained from a vehicle is going to be processed, it is checked whether a voucher assertion exists in relationship with the obtained identifier. If so, the payment of the toll event is ascribed to a second payment account whose existence is asserted by the existence of said voucher assertion. Otherwise, the toll event is ascribed to a first payment account that can be the default one for ascribing the debits of toll events for said identifier.

By controlling the ascription of debits of toll events as described herein, a flexible payment of toll events for a vehicle may be thus be obtained, wherein the same payment account is not necessarily always charged with all the toll events comprising a given toll identifier.

In a simple realization, the voucher assertion may consist on a simple data flag stating the existence of said second payment account, wherein a given second payment account may be related to a plurality of toll identifiers. However, in some cases it may be preferable that a voucher assertion related to a toll identifier further comprises some additional data.

According to various embodiments, the voucher assertion may comprise: a data element stating a time condition, a data element stating a geographical location condition, an identifier of said second payment account, an identifier of a user in a service provider that serves a payment broker service to him, or any combination thereof. The time condition for a voucher assertion may state a period of time in which toll events comprising the toll identifier it relates to are to be ascribed to said second payment account. The geographical location condition for a voucher assertion may state information about one or more geographical locations in which toll events comprising the toll identifier it relates to are to be ascribed to said second payment account. The user identifier in a service provider that acts as payment broker may be usable to identify a payment account of said user in said service provider as said second payment account; wherein, in case said service provider is a telecommunications operator, said user identifier may be usable to identify a communications device of said user connectable to the telecommunications network of said operator.

Accordingly, the existence of a voucher assertion in relationship with a toll identifier does not necessarily imply the ascription of any toll event to said second payment account, but only of those toll events that fits with some requirements which may be set and modified in advance. Further, the voucher assertion may help to identify directly or indirectly said second payment account.

According to one embodiment, the method of the invention comprises a communication between an application server that provides a payment broker service and said toll control server, so as to make said toll control server to store a relationship between a voucher assertion and a toll identifier indicated by said application server in a communication. Therefore, in a further aspect, the invention relates an application server arranged to send to a toll control server a payment authorization request for a toll identifier, said payment authorization request containing a toll identifier obtainable from a vehicle and requesting to ascribe the debit of a toll event that comprises said toll identifier to a second payment account. The method and toll control server of the invention are then further characterized in that any of the following actions is performed at reception of said payment authorization request: a voucher assertion is stored in relationship with a toll identifier indicated in said request, a relationship is established between said toll identifier and a previously stored voucher assertion, or the content of a voucher assertion already stored in relationship with said toll identifier is modified.

According to a further embodiment, a value is set in the time condition data element of a voucher assertion according to the time in which said payment authorization request is received from the application server, wherein said value may determine the start of a period of time in which toll events comprising said toll identifier are to be ascribed to said second payment account. In another embodiment, the content of the data elements that may form the voucher assertion related to a toll identifier may be set and/or modified according to the data content of a received payment authorization request.

According to still a further embodiment, a payment revocation request is sent from an application server to a toll control server requesting to cease the ascription of toll events for a toll identifier to a second payment account; wherein said application server may or may not be the same as the one that might have sent a payment authorization request for said toll identifier. In addition or in replacement of the toll identifier said payment revocation request relates to, a payment revocation request may comprise a data usable to find out the corresponding voucher assertion, and thus, a toll identifier related to it. The reception of a payment revocation request makes the toll control server to, either: remove a voucher assertion stored in relationship with said toll identifier, or break a previously established relationship between said toll identifier and a voucher assertion.

By providing a communication between a toll control server and an application server as described herein, it is possible to dynamically modify or assign the payment account used to ascribe the cost of toll events comprising a given toll identifier, as well as the requirements for ascribing toll events to said account; wherein said modifications may be requested from application server apparatuses of service providers that already holds a payment account for a given user or group of users, or that are entitled to control or authorize the payments to be ascribed to said account.

According to still a further embodiment, the method and application server according to the invention provides a payment broker service to a user that permits said user to send from a communications device a service request for associating a given toll identifier to a given payment account, as said second payment account, or to request the revocation of said association. A service request received from a user may comprise data that can be used by the application server to build up the corresponding payment authorization request or payment revocation request and their respective contents. If the communications device is a mobile communications device, or if the user has a mobile communications device, which is connectable to a telecommunications network of a mobile telecommunications service provider that provides updated geographical location information of mobile communications devices, then, the application server may communicate with a server in said network that provides said kind of information so as to obtain geographical location information of said communications device; thereby, payment authorization requests and/or payment revocation requests may be sent from the application server to one or more toll control servers that control the debiting of toll events for vehicles in a given geographical location, according to the current position of said communications device.

A user may thus request to the application server the ascription of toll events for a given period of time and/or for a given geographical area or areas to a given payment account; wherein toll control servers that control the debiting of toll events for vehicles in the concerned area or areas may be notified from the application server, so as to store or remove a voucher assertion in relationship with a toll identifier of a vehicle driven, occupied or, simply, authorized by said user. Furthermore, a user having a service account with a telecommunications operator may assign through the application server said service account as said second payment account for the payment of toll events for a given toll identifier.

If the user has a mobile communications device connectable to a mobile network, he may be alleviated of having to specify in advance to the application server the geographical area or areas he intends to travel through. If this is the case, the application server may, without requiring further user intervention, periodically obtain the current position of said mobile communications device, so as to send automatically payment authorization requests and/or payment revocation requests to control servers that control the debiting of toll events for vehicles in the concerned area or areas.

### BRIEF DESCRIPTION OF DRAWINGS

FIG. 1 shows a schematic representation of a tele-toll system.

FIG. 2 shows a flowchart representing some procedural steps of a method for processing the debiting of a toll event.

FIG. 3 shows a schematic representation of a tele-toll system, as the one depicted in FIG. 1, further interconnected with a telecommunications network.

FIG. 4, shows a simplified signaling flow taking place between server entities depicted in the interworking scenario shown in FIG. 3.

### DETAILED DESCRIPTION

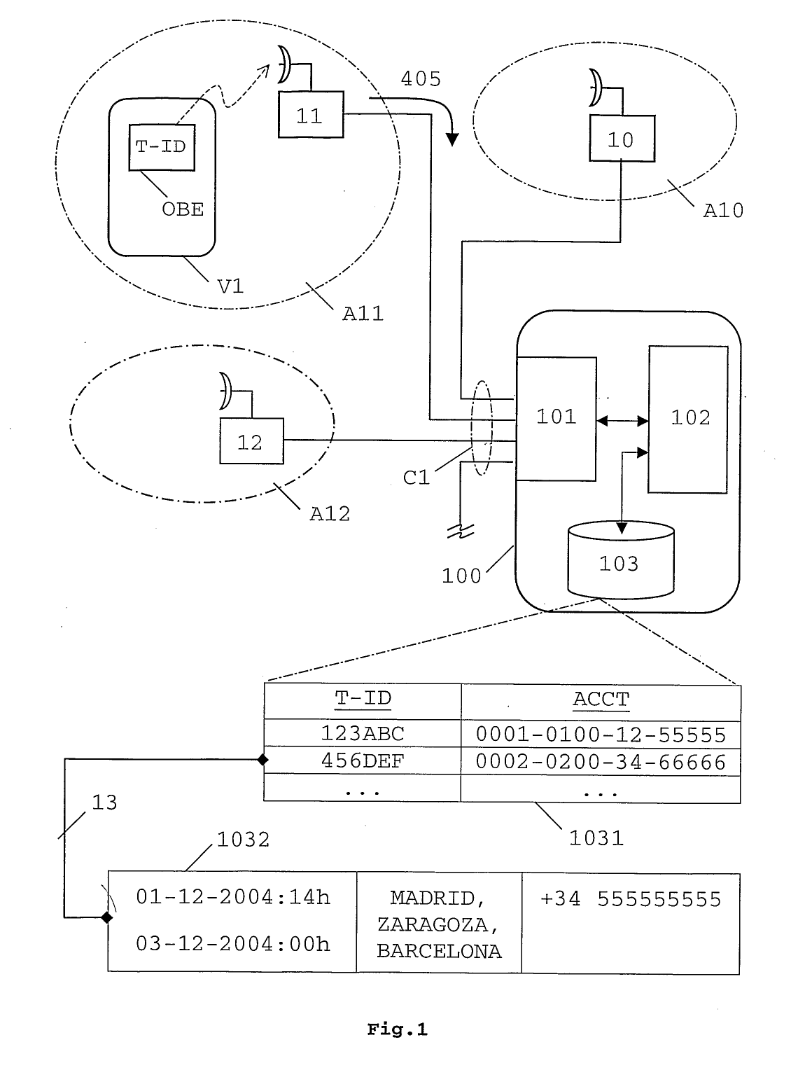

Some exemplary embodiments of the invention shall now be described in detail with references to FIGS. 1 to 4.

As described earlier, the basic functional components of a tele-toll system are the reading station and the toll control server. In practical realizations, the system comprises a plurality of reading stations distributed across different geographical locations, each location corresponding to the entry and/or exit point of a toll road. Depending on selected implementation options, the tele-toll system may comprise one or more toll control servers to perform the aforementioned control and/or toll debiting functions. For example, a toll gantry located at the entry or exit point of a toll road may comprise one or more reading stations, wherein the or each reading station of this point is connected to a toll control server assigned to receive toll events of the reader(s) of this toll gantry, or be connected to a centralized toll control server assigned to receive toll events from reading stations situated in a plurality of different geographical locations. Also, depending on construction details, the same machine may comprise one or more readers arranged to obtain toll identifiers from vehicles, and a processor to perform toll control and/or toll debiting functions (e.g. a computer-based machine with the readers connected as peripheral devices).

For the sake of a better explanation of the invention, the tele-toll system shown schematically in FIG. 1 considers an example case in which a plurality of reading stations (10,11,12), each located in different geographical areas (A10,A11,A12), are connected through communication lines (C1) to a centralized toll control server (100) that is assumed to perform both: toll control and toll debiting functions.

The vehicle V1 mounts an on board equipment (OBE) which comprise a short-range radio transmitter (not detailed in FIG. 1) arranged to emit a particular toll identifier (T-ID). According to the known art, the OBE may be formed by a first element comprising the radio equipment, and a second (usually removable) element that stores the T-ID. When the vehicle passes by the area A11 controlled by the reading station 11, its OBE emits its T-ID and the reading station 11 generates the corresponding toll event 405 which is transmitted to the toll control server 100. The toll event 405 comprises the obtained T-ID and may further comprise some additional data; such as: information about the reading station that reports the event (which, directly or indirectly, may be usable to determine its geographical location), the time in which the toll event has taken place, etc. Alternatively the identity (or location) of the reading station, and/or the time of the toll event may be determined by the toll control server (100). For example, the toll control server may set a time stamp value for a toll event according to the current time it receives the toll event. Also, the control server may determine which reading station reported a received toll event, or in which geographical area said toll event took place, depending on the communication line (C1) said event is received, or depending on an origination address (such as a IP address) in a data packet conveying a toll event message (405).

To perform its functions, the toll control server comprises three functional modules: a communications module (101), a storage module (103), and a processing module (102). The communications module (101) may comprise one or more communication devices (not detailed in FIG. 1), each devoted to a specific kind of communication (e.g. for a given communication protocol, for communications with a certain reading station/s, for communications with certain server entities, etc). The storage module (103) may in turn comprise one or more data storage devices (not detailed in FIG. 1), such as memory chips, magnetic or optical discs, etc; or also external machine(s) devoted to data storage. The processing module (102) may comprise one or more processors (not detailed in FIG. 1), for example, working in load-sharing or active-backup mode. It executes service logic to process the signaling exchanged with reading stations (10,11,12) and other server entities (as will be later referred), as well as to control and/or access the other functional modules (101,103) in the toll control server (100), so as to control the debiting of a toll event as described herein.

FIG. 1 also shows some of the data stored in the storage module (103) of a toll control server (100), as well as the logical relationship established for these data. Numeral 1031 represents a plurality of toll identifiers (T-ID: 123ABC, 456DEF, . . . ) stored in relationship with their corresponding assigned payment accounts (ACCT: 0001-0100-12-55555, 0002-0200-34-66666, . . . ). According to the invention, a voucher assertion (1032) may be related (13) to one or more toll identifiers (456DEF), and shall be used to determine whether a toll event comprising a given toll identifier is to be ascribed to a default payment account (ACCT), or to another payment account. The terms first and second payment accounts are used across this application to refer, respectively, to said default payment account (ACCT) and to said another payment account. The relationship between a toll identifier and a voucher assertion referred across this application may be established, depending on implementation details, directly or indirectly through any of the data that currently may be stored in relationship with a toll identifier in state-of-the-art tele-toll systems.

It shall be noticed that for a given toll identifier (T-ID) that may be known by the toll control server, the default (first) payment account may have a value that implies that no user has subscribed yet an agreement to get assigned said toll identifier; therefore, since the payment of any toll event comprising said toll identifier should, in that situation, be assumed by a tele-toll operator, said value may be understood as representing directly or indirectly a payment account of the tele-toll operator as said first payment account.

In a simple embodiment, a voucher assertion (1032) may consist on a simple data flag stating the existence of said alternative payment account. For example, a tele-toll operator may have an agreement with a service provider providing a payment broker service (e.g. a bank, a credit card payment broker, telecommunications operator, etc), which implies the ascription of some toll debits to a generic account afforded by said service provider; wherein said flag in relationship with a toll identifier would imply toll events of said toll identifier to be ascribed to said generic account (as said second payment account). However, the voucher assertion may comprise further data that may be used, not only to assert the existence of a second payment account, but also to identify it, and/or to identify the user to whom said second payment account belongs to, and/or to state certain conditions for toll events to be ascribed to said second payment account.

The particular embodiment illustrated in FIG. 1 considers a case in which the voucher assertion (1032) comprises: a time condition value (01-12-2004:14h/03-12-2004:00h), a geographical condition value (MADRID, ZARAGOZA, BARCELONA), and a user identifier in a telecommunications service provider (telephone number: +34 555555555). According to this example, toll events comprising the toll identifier 456DEF, may be ascribed to the telephone account of the user having the phone number +34 555555555 in the corresponding telecommunications service provider. Only toll events that take place on toll areas of: Madrid, Zaragoza or Barcelona, and which take place between the 14h of 1December-2004 and 0h of 3December-2004, shall be ascribed to said telephone account. The time condition may be stated so as to represent a period of time (as considered in this example); however, it may also state only an initial time or only an end time for the ascriptions of debits for toll events to said second payment account.

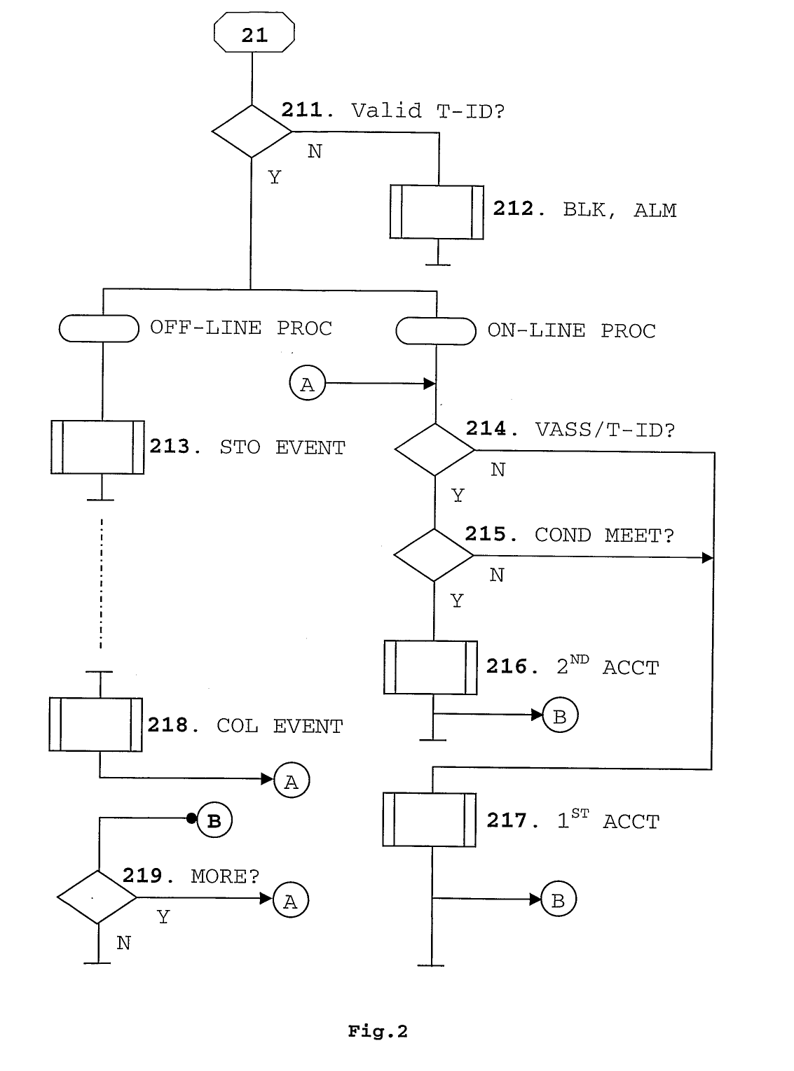

The steps performed by a control server (100) at reception of a toll event (405) reported by a reading station (10,11,12) are represented in FIG. 2.

In step 211, the processing module (102) verifies whether the toll identifier comprised in the received toll event (405) is stored in the storage module (103). If no match is found, then the toll event may be considered as faulty and a further action may be ordered in step 212 (e.g.: ordering to lower a barrier to block the pass of the vehicle, order to emit a warning signal to request the vehicle to stop, order to take a picture of the vehicle comprising its license plate, etc). Step 212 may also comprise the storage of the faulty toll event in a faulty toll event log. If a match is found in step 211, then the process may continue with the ascription of the due debit for said toll event in two different ways: off-line or on-line processing, as described earlier.

If off-line processing is implemented, then, in step 213 the processing module (102) stores in the storage module (103) the relevant data of the received toll event. Although not shown in FIG. 1, the storage module (103) may store further data, mainly if off-line processing is implemented, or if a detailed accounting record is to be delivered to the concerned user or payment broker. Accordingly, the storage module (103) may store a register of toll events, wherein the step 213 would represent the updating of said register. An entry in the toll event register may comprise, in relationship with the toll identifier each toll event relates to: the time in which the toll event took place, and information about the geographical area (A10,A11,A12) in which the toll event took place. As cited earlier, the time and/or geographical information for a toll event may be received from the reading station, or may be determined by the toll control server.

Next steps in the off-line processing flow may take place periodically, wherein step 218 represents the start of the (off-line) processing for the debiting of toll events that have been recorded previously (steps 213). To accomplish with this, the processing module (102) may access to the storage module (103) so as to collect a set of stored entries in the toll event register. Then, the processing a pre-recorded toll event may be executed as for on-line processing, as indicated by the transition flow “A”. In step 214 the processing module (102) checks in the storage module (103) whether a voucher assertion (1032) is stored in relationship with the toll identifier of the processed toll event. If a voucher assertion (1032) is found, then in step 215, the processing module (102) checks whether the toll event meets the condition(s) stated in the related voucher assertion. If any of the conditions checked in step 215 is not meet, or if no voucher assertion is found related to the concerned toll identifier, then the debit of the processed toll event is ascribed to the first payment account (step 217). Otherwise, the debit of the processed toll event is ascribed to the second payment account corresponding to the related voucher assertion (step 216).

For off-line processing, the execution flow continues with the processing of the next recorded toll event, as represented by transition flow “B” and step 219.

Details concerning the actions taken in steps 216 or 217 may vary according to different implementations. In existing tele-toll systems, the step of ascribing the debit of a toll event to a (first, default) payment account (step 217) may comprise the updating of a related accounting balance (which may be also stored in the storage module), for example, by adding the cost of the processed toll event, or deducting the cost of a pre-paid balance; wherein a payment transaction for the total due amount (e.g. in case of post-paid) may take place later with (e.g.) the bank that supports the payments for said account. Alternatively, the step of ascribing the debit of a toll event may comprise the step of communicating directly the debited amount of a toll event to the bank or entity that supports the concerned payment account. Therefore, the step of ascribing a toll event to a second payment account (step 216), may involve similar sub-steps as the ones described above. Consequently, when it is needed to keep an accounting balance (e.g. when post-paid applies), the data structure in the storage module may be adapted so as to allow to record separated accounting balance per payment account, or, at least, to keep track of toll events that shall be ascribed to each payment account. For example, if post-paid applies, a simple realization may be to mark a due toll as ascribed to the corresponding first or second account, or to establish a relationship between them.

The voucher assertion (1032) which is stored in relationship with a toll identifier (T-ID) may be provisioned in the toll control server (100) by the tele-toll operator in a similar way as other data held by said server are currently provisioned (e.g. via configuration commands sent to a toll control server 100). However, further advantages may derive of an automatic communication between one or more toll control servers and one or more application servers of service providers which can mediate in the payment of toll events, so as to achieve a flexible allocation of payment accounts.

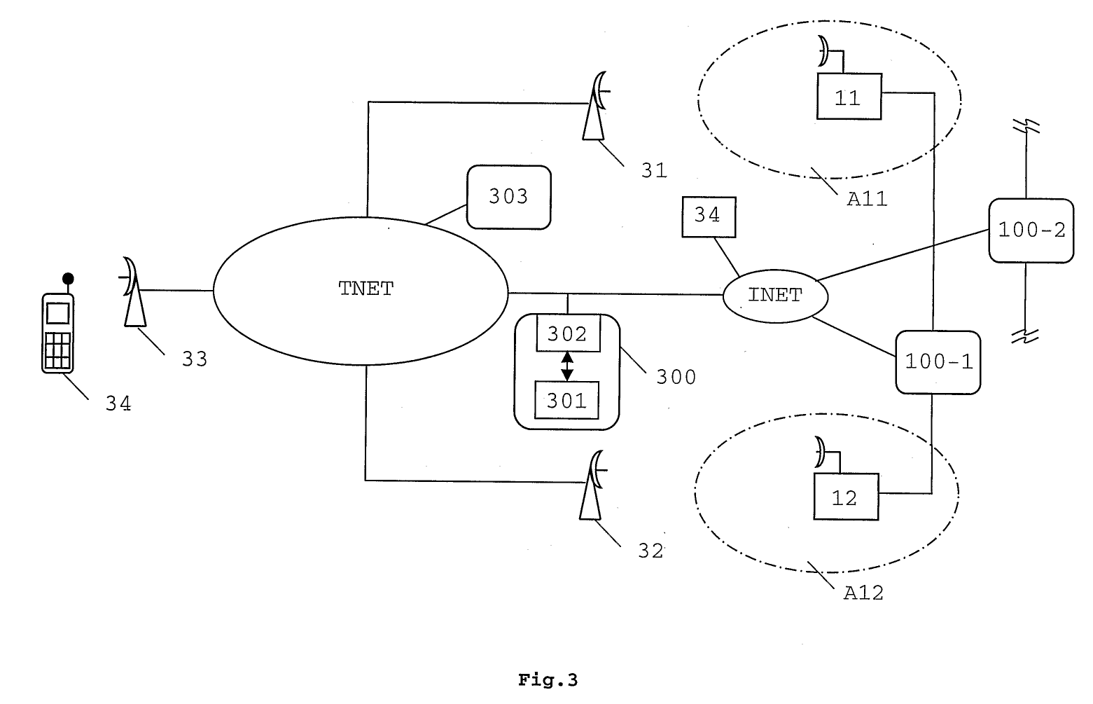

FIG. 3 illustrates an interconnection between a tele-toll system and a telecommunications network. In the figure, two toll control servers (100-1,100-2) are connected to reading stations (11,12) that report toll events from different areas (A11,A12) (reading stations and corresponding areas of toll control server 100-2 are not shown). The toll control servers (100-1,100-2) are further connected through an interconnection network (INET) to a telecommunications network (TNET) that provides a mobile communication service. The interconnection network (INET) may comprise one or more sub-networks, as well as routing, access and gateway nodes (not shown). The telecommunications network (TNET) (that may comprise the network domain of one or more telecommunications operators) comprises radio base stations (31,32,33) located in a plurality of different areas, so as to provide access to a mobile communications device (34) to the communications services provided by or through said network (TNET), as well as telecommunications nodes (not shown) for serving said services or the access to them (e.g. Mobile Switching Centers MSCs, Home Location Registers HLRs, nodes for supporting General Packet Radio Service GPRS, such as SGSNs and GGSNs, gateways for Wireless Application Protocol WAP, etc).

Before going into further details, it shall be noticed that a telecommunications network may be logically divided into: access network(s), core network and service network. For example, a modern telecommunications network implementing 3^{rd} generation mobile technology (also known as “Universal Mobile Telecommunications System” UMTS) admits various kind of access network, such as 2^{nd}generation radio access network, 3^{rd} generation radio access network, or WLAN (Wireless Local Area Network). The core network comprises all the nodes assumed to perform common control and/or routing functions for any communication, regardless the access network to which any of the end-points of a communication (e.g. user terminal, application server, etc) is connected to. Finally, the service network is considered to be comprised by the plurality of application servers intended to provide services to a plurality of users (or to other application servers); preferably, independently of the kind of communication device utilized by the user (e.g. mobile terminal, fixed or wireless PC, etc) and the kind of access network said communication device is connected to (e.g. WLAN, Internet, 2^{nd} or 3^{rd} generation radio network, etc) For this purpose, some mechanisms (such as “Single Sign On” SSO, or “Identity Federation” as defined by Liberty Alliance -http://www.projectliberty.org-) are being developed to permit a user having a subscription with a service provider, such as a mobile telecommunications provider, to access to the services that may be provided by a plurality of application servers in the service layer.

FIG. 3 shows an application server (300) that provides a toll payment broker service. The application server (300) may have a similar structure as the one described earlier for a toll control server (100), and comprise a processing module (301) in cooperation with a communications module (302); wherein the communication module is arranged to communicate with other server entities (303,100-1,100-2) through various communications networks (TNET, INET), and wherein the processing module is arranged to execute the service logic (e.g. by way of computer instructions, if server 300 is a computer-based machine) so as to process the signaling exchanged with other server entities or communication devices (34) to provide the toll payment broker service.

FIG. 3 also shows another server (303) that provides geographical positioning information about mobile communications devices. For example, the telecommunications network (TNET) incorporates a geographical positioning system such as Ericsson's Mobile Positioning System MPS, server 303 may represent the “Serving Mobile Positioning Centre” SMPC of said Mobile Positioning System MPS (http://www.ericsson.com/mobilityworld/sub/open/technologie s/mobile_positioning/index.html; http://www.ericsson.com/mobilityworld/sub/open/technologies/mobile_positioning/about/mps_system_overview). Server 303 might also represent a Home Location Register (HLR), as this kind of node stores information about the global area where a mobile communications device is located (i.e. by way of storing information about the serving MSC or SGSN), which may also be used to accomplish with this embodiment of the invention when no accurate positioning information is required. Also, server 303 might represent a simple positioning server that is arranged to obtain location information from an HLR.

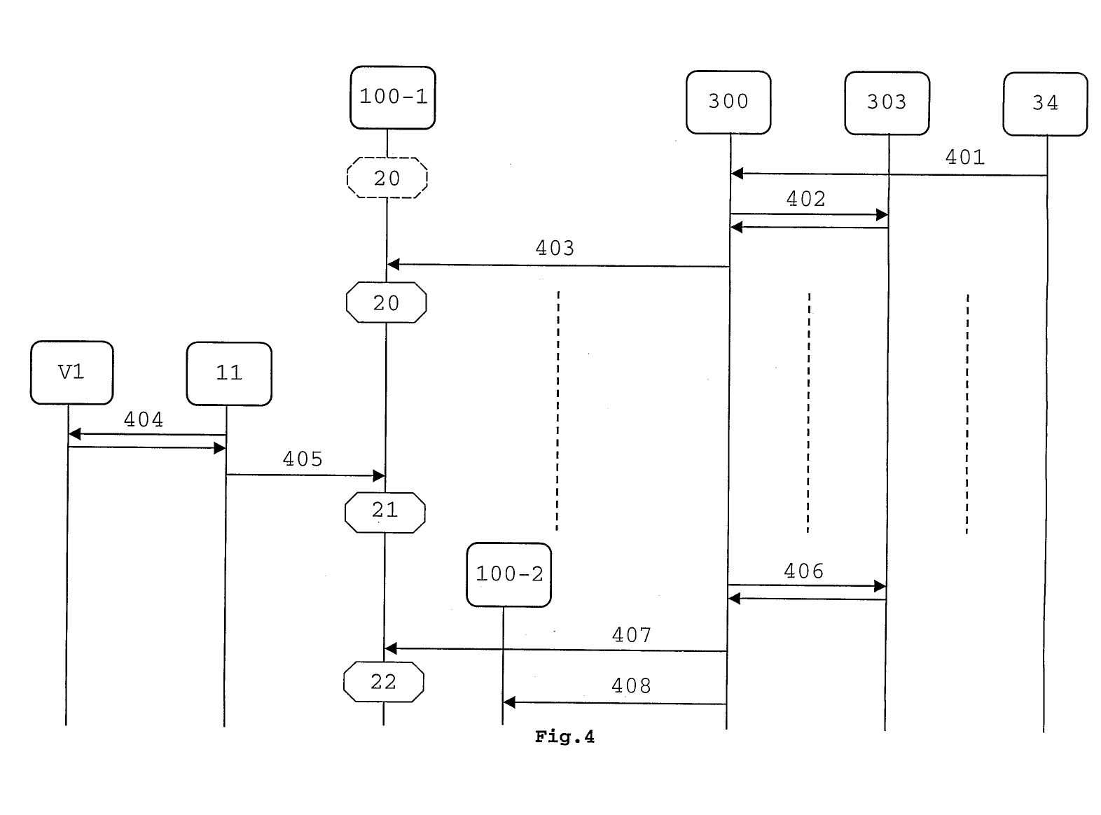

Reference is now made to FIG. 4 to illustrate, by way of some signaling flows that can take place between some of the actors depicted in FIG. 3, some embodiments of the invention that involve communications between an application server that provides a toll payment broker service (300) and a toll control server (100-1,100-2).

Flow 401 represents the arrival to the application server (300) of a service request from a communications device (34) of a user. Although (as illustrated in FIG. 4) it may be advantageous for a user to access to the application server (300) upon desire for requesting the ascription of toll events for a toll identifier to a given payment account, or to revoke said ascription; the application server may be configured to perform any of the actions described hereinafter without any user intervention (e.g. it may be pre-provisioned with toll identifiers, as well as with other related data, so as to act in the described way). The communications device (34) can be a mobile terminal connected to a mobile telecommunications network (TNET), or another kind of communications device, such as a personal computer or a server entitled to request this kind of transactions (e.g. from a bank, car rental company, etc), which may be connected to another network (e.g. as represented by communications device 34 connected to INET). The application server (300) may, for example, offer a web page where a user may indicate the a toll identifier he desires to assign or revoke to a given payment account, as well as credentials that may be used by the application server to identify/authenticate the user and/or to obtain information about said payment account (flows not detailed in FIG. 4); although other kind of communications for receiving the service requests (401) may also be envisaged.

A first example case to illustrate the signaling flows of FIG. 4 may consist on a computer machine (34) of a car rental company that request the ascription of toll event debits for a given toll identifier to the telephone account of a user in a telecommunications service provider (or its revocation); wherein the request may include, together with the toll identifier, a telephone number of said user. A second example case may consist on a user requesting the same kind of service from his mobile communications device (34) via a WAP gateway (not shown) connected to the telecommunications network (TNET), or from a personal computer (34) connected to the Internet (e.g. 34 connected to INET).

If from the information flow(s) of the service request (401) the application server determines that a mobile communications device (34) may be involved (and/or if it is requested to do so), it can periodically obtain (402,406) information about the current geographical location of said mobile communications device from a server (303) that provides geographical location information of mobile communications devices.

Once received a service request (401), the application server builds, based on the content of the request, as well as in further data obtained for said request, payment authorization requests or payment revocation requests (403,407,408) that may be sent to one or more toll control servers (100-1,100-2). In addition to information usable to identify the toll identifier they relate to, and further additional data to control the ascription of debits to a second payment account, payment authorization requests or payment revocation requests may further comprise information that may allow the receiving toll control server to identify and/or authenticate the source of the request, so as to process a received request or to reject it (e.g. the information sent in the requests may be digitally signed by the sender application server).

Flow 403 represents the sending of a payment authorization request that derives from a previous service request (401) to one toll control server (100-1). This may be the case wherein the application server (300) has determined (e.g. based on the content of the service request, and/or based on obtained positioning information 402) that this particular toll control server is to be notified.

For this purpose, the application server (300) may, for example, check data table that relates a toll identifier (or series or identifiers) with identifiers of toll control servers (100-1,100-2) that may be used to address communications to them. Similarly, the application server may check a data table that comprises identifiers of certain geographical areas in relationship with identifiers of toll control servers entitled to ascribe debits of toll events collected in said areas. The application server (300) may have said data table(s) or, alternatively, to obtain the aforementioned relationship from another server(s) that store said kind of information. A simple realization could however consist on provisioning the identifiers of one or a plurality of toll control servers (100-1,100-2) into the application server (100); wherein the payment authorization requests and payment revocation requests would be sent to all of them.

In any case, a selective election in the application server (300) of the target toll control server(s) (100-1,100-2) that should receive a payment authorization request or a payment revocation request (e.g. based on time conditions and/or based on geographical conditions, determined by the application server or received from the requesting user), may provide the advantage of diminishing unnecessary signaling between said application server and toll control servers, and may also make redundant the sending of information about time or geographical conditions in said requests.

When the toll control server 100-1 receives the payment authorization request, it runs process 20, which may comprise the storage of a voucher assertion in relationship with the toll identifier indicated in the request (403). The data content of the stored voucher assertion may be shaped according to the value of data elements contained in the received request (e.g. concerning time, geographical location, identifiers, etc). Voucher assertions may have been previously stored in the toll control server 100-1 before this request (403) is received (e.g. as cited earlier via provisioning, or from a previous payment authorization request). This is represented by dashed box 20 previous to the reception of the payment authorization request of flow 403. Therefore, process 20 may also comprise the establishment of a relationship between a previously stored voucher assertion and a toll identifier indicated in the received request. Furthermore, process 20 may also comprise the modification of the content of a previously stored voucher assertion according to the content of the received request. This latest situation may be originated by a service request (401) that modifies some of the conditions previously requested to ascribe the payment of toll events to the second account, or that modifies some other information concerning said payment (e.g. time condition, location condition, user account, user identifier, etc). If no time information is received in a received payment authorization request (402), process 20 may also comprise the setting of a time value for the aforementioned time condition element of the voucher assertion according to the time in which said request has been received; wherein said time value may determine the start of a period of time in which toll events comprising the indicated toll identifier are to be ascribed to the corresponding second payment account.

Flow 404 represents the capture of the toll identifier (T-ID) of a vehicle (V1) passing by the reading area (A11) of reading station 11. Next, the toll event is notified (405) to the toll control server 100-1, which then runs process 21, described earlier in detail with reference to FIG. 2.

Following the example case cited earlier, the application server obtains (406) again information about the current geographical location of the monitored mobile communications device, and determines that his user has left the geographical area controlled by toll control server 100-1 and now has entered in a geographical area controlled by toll control server 100-2. Accordingly, in flow 407 a payment revocation request for the concerned toll identifier is sent towards toll control server 100-1, and a payment authorization request is sent in flow 408 towards toll control server 100-2. Toll control server 100-2 shall then run process 20 as described earlier with reference to toll control server 100-1. The payment revocation request (407) may comprise the involved toll identifier or another data that may be usable by the toll control server 100-1 to determine said toll identifier; for example, a data that was previously sent in an earlier payment authorization request, such as the telephone number of the user, or the identifier of his payment account. At reception of the payment revocation request (407), toll control server 100-1 runs process 22, which may comprise: the removal of the voucher assertion related to the concerned toll identifier, or the breaking of the relationship (13) stored for them.

State-of-the-art toll control servers of tele-toll operators, as well as application servers of service providers, are commonly implemented in computer-based machines. In these cases, computer programs having computer-readable program codes are loaded in computer-based servers causing them to behave according to a predefined manner that is in accordance to their specific functionality. Accordingly, those skilled in creating and/or modifying computer programs intended to be loaded in a computer-based toll control server or in a computer-based application server, would, without departing of the teachings of the present invention, readily apply them to create and/or modify computer programs that, when executed in a toll control server or in a computer-based application server, would make said servers to behave according to any of the embodiments described heretofore.

The invention has been described in respect to some exemplary embodiments in an illustrative and non-restrictive manner. Variations can be readily apparent to those of ordinary skill in the art. For this reason, the invention is to be interpreted and limited in view of the claims.

1. A method for processing the debiting of a toll event comprising a toll identifier obtained from a vehicle, the method comprising the steps of:
storing information of a first payment account in relationship with a toll identifier obtainable from a vehicle,
ascribing the debit of a reported toll event comprising a toll identifier to a related payment account; and
storing a voucher assertion in relationship with a toll identifier obtainable from a vehicle asserting the existence of a second payment account related to said identifier, wherein the step of ascribing the debit of a reported toll event comprising a toll identifier further comprises the steps of:
checking whether a voucher assertion is related to said toll identifier, and
ascribing the debit of a reported toll event to said first payment account if no voucher assertion is related to said toll identifier, or
ascribing the debit of a reported toll event to said second payment account if a voucher assertion is related to said toll identifier.

2. The method of claim 1, wherein said voucher assertion comprises a data element selected from:
a time condition, stating a period of time in which toll events comprising said toll identifier are to be ascribed to said second payment account,
a geographical location condition, stating information about a geographical location in which toll events comprising said toll identifier are to be ascribed to said second payment account, and wherein the step of checking a voucher assertion for ascribing the debit of a reported toll event comprises at least one step selected from:
checking the time in which said toll event took place against said time condition,
checking the information about the geographical location in which said toll event took place against said geographical location condition, to determine whether said toll event is to be ascribed to said second payment account or to said first payment account.

3. The method of claim 1, wherein said voucher assertion comprises a data element selected from:
an identifier of said second payment account, and
a user identifier of a user in a service provider serving a payment broker service, said identifier being usable to identify a payment account of said user in said service provider as said second payment account.

4. The method of claim 1, further comprising the previous step of:
sending from an application server providing a payment broker service, a payment authorization request containing a toll identifier obtainable from a vehicle and requesting to ascribe the debit of a toll event that comprises said toll identifier to a second payment account, and
receiving said payment authorization request in a toll control server controlling the debiting of a toll for a vehicle, and wherein the step of storing a voucher assertion further comprises one step selected from:
storing in said toll control server a voucher assertion in relationship with a toll identifier contained in said request,
establishing in said toll control server a relationship between a previously stored voucher assertion and a toll identifier contained in said request, and
modifying in said toll control server the content of a voucher assertion previously stored in relationship with a toll identifier contained in said request.

5. The method of claim 4, further comprising the step of:
setting a value in said time condition data element according to the time in which said payment authorization request is received in said toll control server, said value determining the start of a period of time in which toll events comprising said toll identifier are to be ascribed to said second payment account.

6. The method of claim 4, further comprising the step of:
setting in said toll control server at least part of the content of said voucher assertion according to the content of a data element received in said payment authorization request.

7. The method of claim 4, further comprising the steps of:
sending from an application server providing a payment broker service, a payment revocation request for a toll identifier, said request comprising: at least a toll identifier, or at least part of a voucher assertion related to said identifier, and
receiving said payment revocation request in said toll control server, and one step selected from:
removing in said toll control server a voucher assertion stored in relationship with said toll identifier, or
breaking in said toll control server a previously established relationship between said toll identifier and a voucher assertion.

8. The method of claim 4, further comprising the previous steps of:
receiving in said application server a service request from a communications device of a user through a telecommunications network of a telecommunications service provider, and
sending said payment authorization request or said payment revocation request based on the content of said service request.

9. The method of claim 8, wherein said second payment account is a payment account of said user in said telecommunications service provider.

10. The method of claim 8, wherein a communications device of said user is connectable to a telecommunications network of a mobile telecommunications service provider, further comprising the step of:
obtaining from said application server geographical location information of said communications device of said user from said telecommunications network, and wherein the step of sending said payment authorization request or said payment revocation request from said application server further comprises the steps of:
obtaining information to address a toll control server that controls the debiting of toll events for vehicles in a given geographical location, and
sending said payment authorization request or payment revocation request to a toll control server according to the obtained geographical location information of said communications device.

11. A toll control server for controlling the debiting of a toll event comprising a toll identifier obtained from a vehicle, the control server comprising:
a storage module for storing information of a first payment account in relationship with a toll identifier obtainable from a vehicle, and
a processing module for ascribing the debit of a reported toll event comprising said toll identifier to a first payment account related to said identifier;
said storage module further for storing a voucher assertion in relationship with a toll identifier obtainable from a vehicle asserting the existence of a second payment account related to said identifier, and
said processing module is arranged to check a voucher assertion related to an obtained toll identifier to determine whether the debit of a reported toll event comprising said identifier is to be ascribed to a first payment account or to a second payment account.

12. The control server of claim 11, wherein said voucher assertion comprises a data element stating a time condition, said processing module being adapted to check the time in which a toll event comprising said identifier took place against said time condition to determine whether said toll event is to be ascribed to said second payment account.

13. The control server of claim 11, wherein said voucher assertion comprises a data element stating a geographical location condition, and wherein said processing module is adapted to check the information about the geographical location in which a toll event comprising said identifier took place against said geographical location condition to determine whether said toll event is to be ascribed to said second payment account.

14. The control server of claim 11, wherein said voucher assertion comprises a data element containing an identifier of said second payment account.

15. The control server of claim 11, wherein said voucher assertion comprises a data element containing a user identifier of a user in a service provider serving a payment broker service and is usable to identify a payment account of said user in said service provider as said second payment account.

16. The control server of claim 15, wherein said service provider is a telecommunications service provider, and said user identifier is usable to address a communications device of said user connectable to a telecommunications network of said service provider.

17. The control server of claim 11 further comprising
a communications module in cooperation with said processing module to receive a payment authorization request for a toll identifier from an application server providing a toll payment broker service, wherein said processing module is responsive to the reception of said request so as to:
store in said storage module a voucher assertion in relationship with a toll identifier contained in said request, or
establish in said storage module a relationship between a previously stored voucher assertion and a toll identifier contained in said request, or
modify in said storage module the content of a voucher assertion previously stored in relationship with a toll identifier contained in said request.

18. The control server of claim 17, wherein said processing module is adapted to set a value in said time condition data element according to the time in which said payment authorization request is received, said value determining the start of a period of time in which toll events comprising said toll identifier are to be ascribed to said second payment account.

19. The control server of claim 17, wherein said processing module is adapted to set at least part of the content of said voucher assertion according to the content of a data element received in said payment authorization request.

20. The control server of claim 17, wherein said communications module is adapted to receive from an application server providing a payment broker service, a payment revocation request for a toll identifier, said request comprising: at least a toll identifier, or at least part of a voucher assertion related to said identifier, said processing module is responsive to the reception of said request so as to:
remove a voucher assertion stored in said storage module in relationship with said toll identifier, or
break in said storage module a previously established relationship between said toll identifier and a voucher assertion.

21. An application server for providing a service to a user, the application server comprising:
a communications module for receiving a service request, and
a processing module in cooperation with said communications module executing service logic for providing the requested service; for providing a toll payment broker service to a user, said processing module being adapted to prompt said communications module to send a payment authorization request for a toll identifier to
a toll control server that ascribes the debiting of a toll event comprising
a toll identifier obtained from a vehicle to a related first payment account, said payment authorization request containing a toll identifier obtainable from a vehicle and requesting to ascribe the debit of a toll event that comprises said toll identifier to a second payment account.

22. The application server of claim 21, wherein said payment authorization request comprises a further data element selected from:
a time condition, stating a period of time in which toll events comprising said toll identifier are to be ascribed to said second payment account,
a geographical location condition, stating information about a geographical location in which toll events comprising said toll identifier are to be ascribed to said second payment account,
an identifier of said second payment account, and
a user identifier of a user in a service provider serving a payment broker service, said identifier being usable to identify a payment account of said user in said service provider as said second payment account.

23. The application server of claim 21, wherein said processing module is adapted to prompt said communications module to send a payment revocation request for a toll identifier to said toll control server, said payment revocation request comprising at least a data element sent in a previous payment authorization request.

24. The application server of claim 21, wherein said communications module is arranged to receive a service request from a communications device of a user, and wherein said processing module is responsive to the reception of said request so as to build up said payment authorization request or said payment revocation request based on the content of said service request.

25. The application server of claim 24, wherein a communications device of said user is connectable to a telecommunications network of a mobile telecommunications service provider, said communications module being adapted to communicate with a server that provides geographical location information of mobile communications devices in said network, and wherein said processing module is adapted to prompt said communications module to establish a communication with said server in said network for obtaining geographical location information of said communications device.

26. The application server of claim 25, wherein said second payment account is a payment account of said user in said telecommunications service provider.

27. The application server of claim 25 wherein said processing module is further adapted
to obtain information to address a toll control server that controls the debiting of toll events for vehicles in a given geographical location, and
to send said payment authorization request or payment revocation request to a toll control server according to the obtained geographical location information of said communications device.

28. A system for processing the debiting of a toll event comprising a toll identifier obtained from a vehicle 7
a toll control server comprising:
a communications module in cooperation with said processing module to receive a payment authorization request for a toll identifier from an application server providing a toll payment broker service, wherein said processing module is responsive to the reception of said request so as to:
store in said storage module a voucher assertion in relationship with a toll identifier contained in said request, or
establish in said storage module a relationship between a previously stored voucher assertion and a toll identifier contained in said request, or
modify in said storage module the content of a voucher assertion previously stored in relationship with a toll identifier contained in said request and
an application server comprising:
a communications module for receiving a service request, and
a processing module in cooperation with said communications module executing service logic for providing the requested service; for providing a toll payment broker service to a user, said processing module being adapted to prompt said communications module to send a payment authorization request for a toll identifier to
a toll control server that ascribes the debiting of a toll event comprising
a toll identifier obtained from a vehicle to a related first payment account, said payment authorization request containing a toll identifier obtainable from a vehicle and requesting to ascribe the debit of a toll event that comprises said toll identifier to a second payment account.

29.-30. (canceled)
